(19) United States
(12) Patent Application Publication
(10) Pub. No.: US 2024/0343642 A1
(43) Pub. Date: Oct. 17, 2024

(54) RESIN COMPOSITION FOR COLORED COATING ON OPTICAL FIBER, OPTICAL FIBER, AND OPTICAL FIBER RIBBON

(71) Applicant: SUMITOMO ELECTRIC INDUSTRIES, LTD., Osaka (JP)

(72) Inventors: Katsushi HAMAKUBO, Osaka (JP); Noriaki IWAGUCHI, Osaka (JP); Miho IKEGAWA, Osaka (JP)

(21) Appl. No.: 18/755,868

(22) Filed: Jun. 27, 2024

(30) Foreign Application Priority Data
Jul. 18, 2023 (JP) 2023-116522

(51) Int. Cl. C03C 25/475; C03C 25/1065; C03C 25/47; C08K 3/22; C09D 4/00; C09D 7/61; C09D 135/02; G02B 6/02; G02B 6/44

(52) U.S. Cl. CPC C03C 25/475; C03C 25/1065; C03C 25/47; C09D 4/00; C09D 7/61; C09D 135/02; G02B 6/02395; G02B 6/4403; C08K 2003/2241

(57) ABSTRACT

A resin composition for colored coating on an optical fiber contains a photopolymerizable compound, and a photopolymerization initiator, in which the photopolymerization initiator contains an acyl phosphine oxide compound that is in a liquid state at 25° C.

### CROSS-REFERENCE TO RELATED APPLICATIONS

This application claims priority based on Japanese Patent Application No. 2023-116522 filed on Jul. 18, 2023, and incorporates all the contents described in the Japanese patent application.

### TECHNICAL FIELD

The present disclosure relates to a resin composition for colored coating on an optical fiber, an optical fiber, and an optical fiber ribbon.

### BACKGROUND

In general, an optical fiber includes a coating resin layer for protecting a glass fiber that is an optical transmission medium. The coating resin layer, for example, includes a primary resin layer and a secondary resin layer. The outermost layer of the coating resin layer is composed of a colored resin layer for identifying the optical fiber (for example, refer to JP H6-242355A, JP 2003-279811A, and WO 2016/047002 A1).

### SUMMARY

A resin composition for colored coating on an optical fiber according to one aspect of the present disclosure contains a photopolymerizable compound, and a photopolymerization initiator, in which the photopolymerization initiator contains an acyl phosphine oxide compound that is in a liquid state at 25° C.

### BRIEF DESCRIPTION OF THE DRAWINGS

FIG. 1 is a schematic cross-sectional view illustrating an example of an optical fiber according to this embodiment.

FIG. 2 is a schematic cross-sectional view illustrating an example of the optical fiber according to this embodiment.

FIG. 3 is a schematic cross-sectional view illustrating an example of an optical fiber ribbon according to this embodiment.

### DETAILED DESCRIPTION

An optical fiber may be used in the form of an optical fiber ribbon in which a plurality of optical fibers are arranged and integrated with a ribbon resin. In an optical fiber ribbon using an optical fiber including a colored resin layer, when performing an operation of extracting the optical fiber by removing a ribbon material, a phenomenon that the colored resin layer is peeled from the optical fiber, a so-called “color peeling” may occur. In particular, in a case where a linear speed when forming the colored resin layer is increased, the color peeling easily occurs. There is a demand for a resin composition for colored coating on an optical fiber that is capable of further suppressing the color peeling.

An object of the present disclosure is to provide a resin composition for colored coating on an optical fiber that is capable of producing an optical fiber less likely to cause color peeling, an optical fiber, and an optical fiber ribbon.

According to the present disclosure, it is possible to provide a resin composition for colored coating on an optical fiber that is capable of producing the optical fiber less likely to cause the color peeling, an optical fiber, and an optical fiber ribbon.

First, the contents of embodiments of the present disclosure will be listed and described.
(1) A resin composition for colored coating on an optical fiber according to one aspect of the present disclosure contains a photopolymerizable compound, and a photopolymerization initiator, in which the photopolymerization initiator contains an acyl phosphine oxide compound that is in a liquid state at 25° C. By using the acyl phosphine oxide compound that is in a liquid state at 25° C. as the photopolymerization initiator, it is possible for such a resin composition to produce an optical fiber less likely to cause color peeling.
(2) In (1) described above, from the viewpoint of further suppressing the color peeling, the acyl phosphine oxide compound may have at least one 2,4,6-trimethyl benzoyl group.
(3) In (1) or (2) described above, from the viewpoint of further suppressing the color peeling, the acyl phosphine oxide compound may include at least one type selected from the group consisting of ethyl phenyl (2,4,6-trimethyl benzoyl) phosphinate, di(2,4,6-trimethyl benzoyl) phosphinic acid polyethylene glycol ester, and tri[phenyl(2,4,6-trimethyl benzoyl) phosphinic acid] polyethylene glycol ester.
(4) In any one of (1) to (3) described above, from the viewpoint of further suppressing the color peeling, a content of the acyl phosphine oxide compound may be 0.01% by mass or more and 5.0% by mass or less with respect to a total amount of the photopolymerizable compound.
(5) In any one of (1) to (4) described above, from the viewpoint of coloring a resin layer, the resin composition may further contain a titanium oxide particle.
(6) An optical fiber according to one aspect of the present disclosure includes a glass fiber including a core and a clad, a primary resin layer covering the glass fiber in contact with the glass fiber, a secondary resin layer covering the primary resin layer, and a colored resin layer covering the secondary resin layer, in which the colored resin layer contains a cured product of the resin composition according to any one of (1) to (5) described above. Such an optical fiber is less likely to cause color peeling.
(7) An optical fiber according to one aspect of the present disclosure includes a glass fiber including a core and a clad, a primary resin layer covering the glass fiber in contact with the glass fiber, and a secondary resin layer covering the primary resin layer, in which the secondary resin layer contains a cured product of the resin composition according to any one of (1) to (5) described above. Such an optical fiber is less likely to cause color peeling.
(8) An optical fiber ribbon according to one aspect of the present disclosure in which a plurality of the optical fibers according to (6) or (7) described above are arranged in parallel, and coated with a ribbon resin. Such an optical fiber ribbon is less likely to cause color peeling when performing an operation of extracting the optical fiber, and is capable of easily identifying the optical fiber.

Specific examples of a resin composition, an optical fiber, and an optical fiber ribbon according to embodiments of the present disclosure will be described with reference to the drawings as necessary. Note that, the present disclosure is not limited to such examples, but is indicated by the claims, and is intended to include the meaning equivalent to the claims and all modifications within the claims. In the following description, the same reference numerals will be applied to the same constituents in the description of the drawings, and repeated description will be omitted. In this specification, (meth)acrylate indicates acrylate or methacrylate corresponding thereto. The same applies to other similar expressions such as (meth)acryloyl.

### (Resin Composition)

A resin composition for colored coating on an optical fiber according to this embodiment contains a photopolymerizable compound and a photopolymerization initiator, in which the photopolymerization initiator contains an acyl phosphine oxide compound that is in a liquid state at 25° C.

The photopolymerizable compound is not particularly limited. The photopolymerizable compound is distinguished from a polydimethyl siloxane compound having a (meth)acryloyl group described below from the viewpoint that the photopolymerizable compound does not have a dimethyl siloxane skeleton. From the viewpoint of increasing the strength of a resin layer, the photopolymerizable compound may include epoxy di(meth)acrylate. As the epoxy di(meth)acrylate, for example, a reactant of a diglycidyl ether compound having a bisphenol skeleton and a compound having a (meth)acryloyl group such as a (meth)acrylic acid can be used. Only one type of the epoxy di(meth)acrylates may be used alone, or two or more types thereof may be used by being mixed.

Examples of the epoxy di(meth)acrylate include a (meth)acrylic acid adduct of bisphenol A diglycidyl ether, a (meth)acrylic acid adduct of bisphenol AF diglycidyl ether, and a (meth)acrylic acid adduct of bisphenol F diglycidyl ether.

From the viewpoint of further increasing the strength of the resin layer, the content of the epoxy di(meth)acrylate may be 30 parts by mass or more, 40 parts by mass or more, or 45 parts by mass or more, and may be 70 parts by mass or less, 65 parts by mass or less, or 60 parts by mass or less, on the basis of the total amount of 100 parts by mass of the photopolymerizable compound.

The photopolymerizable compound, from the viewpoint of adjusting the Young's modulus of the resin layer, may further include urethane (meth)acrylate. As the urethane (meth)acrylate, for example, a reactant of a polyol compound, a polyisocyanate compound, and a hydroxyl group-containing (meth)acrylate compound can be used. Only one type of the urethane (meth)acrylates may be used alone, or two or more types thereof may be used by being mixed.

Examples of the polyol compound include polytetramethylene glycol, polypropylene glycol, and bisphenol A/ethylene oxide addition diol. Examples of the polyisocyanate compound include 2,4-tolylene diisocyanate, 2,6-tolylene diisocyanate, isophorone diisocyanate, and dicyclohexyl methane 4,4′-diisocyanate. Examples of the hydroxyl group-containing (meth)acrylate compound include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol mono(meth)acrylate.

From the viewpoint of adjusting the Young's modulus of the resin layer, the number average molecular weight (Mn) of the polyol compound may be 300 or more and 3000 or less, 400 or more and 3000 or less, or 500 or more and 2500 or less.

As a catalyst when synthesizing the urethane (meth)acrylate, an organic tin compound is generally used. Examples of the organic tin compound include dibutyl tin dilaurate, dibutyl tin diacetate, dibutyl tin malate, dibutyl tin bis(2-ethyl hexyl mercaptoacetate), dibutyl tin bis(isooctyl mercaptoacetate), and dibutyl tin oxide. From the viewpoint of availability and catalyst performance, dibutyl tin dilaurate or dibutyl tin diacetate may be used as the catalyst.

When synthesizing the urethane (meth)acrylate, lower alcohol having 5 or less carbon atoms may be used. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

The photopolymerizable compound may further include a photopolymerizable compound (hereinafter, referred to as a “monomer”) other than the epoxy di(meth)acrylate and the urethane (meth)acrylate.

Examples of the monomer include a monofunctional monomer having one polymerizable group, and a polyfunctional monomer having two or more polymerizable groups. Only one type of the monomers may be used alone, or two or more types thereof may be used by being mixed.

Examples of the monofunctional monomer include a (meth)acrylate-based monomer such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl(meth)acrylate, heptyl (meth)acrylate, isoamyl (meth)acrylate, 2-ethyl hexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxydiethylene glycol acrylate, phenoxypolyethylene glycol acrylate, 4-tert-butyl cyclohexanol acrylate, tetrahydrofurfuryl (meth)acrylate, benzyl (meth)acrylate, dicyclopentenyl (meth)acrylate, dicyclopentenyl oxyethyl (meth)acrylate, dicyclopentanyl (meth)acrylate, nonyl phenol polyethylene glycol (meth)acrylate, nonyl phenoxypolyethylene glycol (meth)acrylate, and isobornyl (meth)acrylate; a carboxy group-containing monomer such as a (meth)acrylic acid, a (meth)acrylic acid dimer, carboxyethyl (meth)acrylate, carboxypentyl (meth)acrylate, and ω-carboxy-polycaprolactone (meth)acrylate; a heterocyclic ring-containing monomer such as N-(meth)acryloyl morpholine, N-vinyl pyrrolidone, N-vinyl caprolactam, N-(meth)acryloyl piperidine, N-(meth)acryloyl pyrrolidine, 3-(3-pyridine) propyl (meth)acrylate, and cyclic trimethylol propane formal acrylate; a maleimide-based monomer such as maleimide, N-cyclohexyl maleimide, and N-phenyl maleimide; an amide-based monomer such as (meth)acrylamide, N,N-dimethyl (meth)acrylamide, N,N-diethyl (meth)acrylamide, N-hexyl (meth)acrylamide, N-methyl (meth)acrylamide, N-ethyl (meth)acrylamide, N-butyl (meth)acrylamide, N-methylol (meth)acrylamide, and N-methylol propane (meth)acrylamide; an aminoalkyl (meth)acrylate-based monomer such as aminoethyl (meth)acrylate, aminopropyl (meth)acrylate, N,N-dimethyl aminoethyl (meth)acrylate, and tert-butyl aminoethyl (meth)acrylate; and a succinimide-based monomer such as N-(meth)acryloyl oxymethylene succinimide, N-(meth)acryloyl-6-oxyhexamethylene succinimide, and N-(meth)acryloyl-8-oxyoctamethylene succinimide.

Examples of the polyfunctional monomer include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, propylene oxide-modified neopentyl glycol di(meth)acrylate, polytetraethylene glycol di(meth)acrylate, neopentyl glycol hydroxypivalate di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, neopentyl glycol di(meth)acrylate, isopentyl diol di(meth)acrylate, 3-ethyl-1,8-octanediol di(meth)acrylate; trimethylol propane tri(meth)acrylate, trimethylol octane tri(meth)acrylate, trimethylol propane polyethoxytri(meth)acrylate, trimethylol propane polypropoxytri(meth)acrylate, trimethylol propane polyethoxypolypropoxytri(meth)acrylate, tris[(meth)acryloyl oxyethyl] isocyanurate, pentaerythritol tri(meth)acrylate, pentaerythritol polyethoxytetra(meth)acrylate, pentaerythritol polypropoxytetra(meth)acrylate, pentaerythritol tetra(meth)acrylate, ditrimethylol propane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyl oxyethyl] isocyanurate.

The photopolymerizable compound, from the viewpoint of adjusting the Young's modulus of the resin layer, may contain an alkylene oxide-modified polyfunctional monomer. The alkylene oxide-modified polyfunctional monomer may have at least one type selected from the group consisting of an ethylene oxide (EO) chain and a propylene oxide (PO) chain. The ethylene oxide chain can be represented as “(EO)n”, and the propylene oxide chain can be represented as “(PO)n”. n is an integer of 1 or more, may be an integer of 2 or more, or 3 or more, and may be an integer of 30 or less, 25 or less, or 20 or less. Examples of the alkylene oxide-modified polyfunctional monomer include alkylene oxide-modified di(meth)acrylate and alkylene oxide-modified tri(meth)acrylate.

Examples of the alkylene oxide-modified di(meth)acrylate include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, and propylene oxide-modified neopentyl glycol di(meth)acrylate.

Examples of the alkylene oxide-modified tri(meth)acrylate include trimethylol propane tri(meth)acrylate, trimethylol octane tri(meth)acrylate, trimethylol propane polyethoxytri(meth)acrylate, trimethylol propane polypropoxytri(meth)acrylate, trimethylol propane polyethoxypolypropoxytri(meth)acrylate, tris[(meth)acryloyl oxyethyl] isocyanurate, and pentaerythritol tri(meth)acrylate.

The photopolymerization initiator contains the acyl phosphine oxide compound that is in a liquid state at 25° C. (hereinafter, referred to as a “liquid acyl phosphine oxide compound”). Here, the liquid state indicates a state of having fluidity at ordinary temperature and pressure (25° C., 1 atm), and includes a liquid state or a starch syrup state. By using the liquid acyl phosphine oxide compound as the photopolymerization initiator, it is possible for the resin composition according to this embodiment to produce an optical fiber less likely to cause color peeling.

The liquid acyl phosphine oxide compound, from the viewpoint of further suppressing the color peeling, may have at least one 2,4,6-trimethyl benzoyl group. The number of 2,4,6-trimethyl benzoyl groups in the liquid acyl phosphine oxide compound may be 2 or more, or 3 or more. Examples of the liquid acyl phosphine oxide compound having at least one 2,4,6-trimethyl benzoyl group include ethyl phenyl (2,4,6-trimethyl benzoyl) phosphinate (Omnirad TPO-L, manufactured by IGM Resins B.V.), di(2,4,6-trimethyl benzoyl) phosphinic acid polyethylene glycol ester (Omnirad 820, manufactured by IGM Resins B.V.), and tri[phenyl (2,4,6-trimethyl benzoyl) phosphinic acid] polyethylene glycol ester (Omnipol TP, manufactured by IGM Resins B.V.). Only one type of the liquid acyl phosphine oxide compounds may be used alone, or two or more types thereof may be used by being mixed.

The content of the liquid acyl phosphine oxide compound, from the viewpoint of further suppressing the color peeling, may be 0.01% by mass or more, 0.03% by mass or more, 0.05% by mass or more, 0.07% by mass or more, or 0.09% by mass or more, and may be 5.0% by mass or less, 4.0% by mass or less, 3.0% by mass or less, 2.0% by mass or less, or 1.5% by mass or less, with respect to the total amount of the photopolymerizable compound. The content of the liquid acyl phosphine oxide compound, from the viewpoint of further suppressing the color peeling, may be 0.01% by mass or more and 5.0% by mass or less, 0.03% by mass or more and 4.0% by mass or less, 0.05% by mass or more and 3.0% by mass or less, 0.07% by mass or more and 2.0% by mass or less, or 0.09% by mass or more and 1.5% by mass or less, with respect to the total amount of the photopolymerizable compound.

The photopolymerization initiator may further include other photopolymerization initiators unless contrary to the gist of the present disclosure. Examples of the other photopolymerization initiators include 1-hydroxycyclohexyl phenyl ketone (Omnirad 184, manufactured by IGM Resins B.V.), 2-hydroxy-2-methyl-1-phenyl propanone (Omnirad 1173, manufactured by IGM Resins B.V.), 2,2-dimethoxy-2-phenyl acetophenone, 1-(4-isopropyl phenyl)-2-hydroxy-2-methyl propan-1-one, and 2-methyl-1-[4-(methyl thio)phenyl]-2-morpholino-propan-1-one (Omnirad 907, manufactured by IGM Resins B.V.).

The content of the photopolymerization initiator may be 1% by mass or more and 10% by mass or less, 2% by mass or more and 8% by mass or less, or 3% by mass or more and 7% by mass or less, with respect to the total amount of the photopolymerizable compound.

The resin composition according to this embodiment, from the viewpoint of coloring the resin layer, may further contain titanium oxide particles. As the titanium oxide particles, surface-treated titanium oxide particles may be used. The surface-treated titanium oxide particles are particles in which titanium oxide is subjected to a surface treatment using an inorganic substance, and are excellent in dispersibility in the resin composition.

Examples of the inorganic substance used for the surface treatment include aluminum oxide, silicon dioxide, and zirconium dioxide. By the surface-treated titanium oxide particles including a surface-treated layer containing at least one type selected from the group consisting of aluminum oxide, silicon dioxide, and zirconium dioxide, it is possible to further improve the dispersibility. The surface-treated layer may be formed on at least a part of the surface of the titanium oxide particles, or may be formed on the entire surface of the titanium oxide particles. The surface-treated layer is formed by the surface treatment of the titanium oxide particles.

The amount of the surface-treated layer in the surface-treated titanium oxide particles, from the viewpoint of further improving the dispersibility, may be 1.0% by mass or more, 1.5% by mass or more, or 2.0% by mass or more, and from the viewpoint of increasing a hiding power, may be 10.0% by mass or less, 9.0% by mass or less, or 8.0% by mass or less. The amount of the surface-treated layer can be calculated by measuring the amount of titanium elements and elements of the inorganic substance other than titanium, contained in the surface-treated titanium oxide particles, using inductively coupled mass spectrometry (ICP-MS).

The average primary particle diameter of the titanium oxide particles, from the viewpoint of improving the lateral pressure resistance of a coating resin layer, may be 300 nm or less, 295 nm or less, or 290 nm or less. The average primary particle diameter of the titanium oxide particles, from the viewpoint of increasing the hiding power, may be 100 nm or more, 150 nm or more, or 200 nm or more. The average primary particle diameter of the titanium oxide particles may be 200 nm or more and 300 nm or less. The average primary particle diameter, for example, can be measured by the image analysis of an electron microgram, a light scattering method, a BET method, and the like.

The content of the titanium oxide particles, from the viewpoint of improving the visibility of the resin layer, may be 0.6% by mass or more, 1.0% by mass or more, 2.0% by mass or more, or 3.0% by mass or more, with respect to the total amount of the photopolymerizable compound. The content of the titanium oxide particles, from the viewpoint of increasing the curability of the resin composition, may be 20% by mass or less, 15% by mass or less, 10% by mass or less, or 8% by mass or less, with respect to the total amount of the photopolymerizable compound.

The resin composition according to this embodiment, from the viewpoint of the lateral pressure resistance of the optical fiber, may further contain a polydimethyl siloxane compound. The polydimethyl siloxane compound is a compound having a dimethyl siloxane skeleton (—Si(CH₃)₂O—) composed of two methyl groups bonded to a silicon atom and an oxygen atom as a repeating unit on a main chain.

The amount of the silicon atoms (Si) contained in the polydimethyl siloxane compound, from the viewpoint of the lateral pressure resistance, may be 6% by mass or more, 8% by mass or more, 10% by mass or more, or 12% by mass or more. The amount of Si, from the viewpoint of the stability of the resin composition, may be 40% by mass or less, 30% by mass or less, 25% by mass or less, or 21% by mass or less. The amount of Si contained in the polydimethyl siloxane compound can be measured by inductively coupled plasma optical emission spectrometry (ICP-OES) of the polydimethyl siloxane compound.

The polydimethyl siloxane compound, from the viewpoint of the lateral pressure resistance and hot-water resistance, may have at least one type of organic group selected from the group consisting of a (meth)acryloyl group, an epoxy group, and a polyether group. That is, the polydimethyl siloxane compound, from the viewpoint of the lateral pressure resistance and the hot-water resistance, may include at least one type selected from the group consisting of a polydimethyl siloxane compound having a (meth)acryloyl group, a polydimethyl siloxane compound having an epoxy group, and a polydimethyl siloxane compound having a polyether group. The polydimethyl siloxane compound may have such organic groups on a side chain or a terminal. Among such organic groups, from the viewpoint of the lateral pressure resistance and the hot-water resistance, the (meth)acryloyl group and the epoxy group are preferable, and the (meth)acryloyl group is more preferable.

The polydimethyl siloxane compound having a (meth)acryloyl group can be copolymerized with the photopolymerizable compound described above. The polydimethyl siloxane compound having a (meth)acryloyl group is not included in the photopolymerizable compound described above. The number of (meth)acryloyl groups in the polydimethyl siloxane compound may be 1 or more, or 2 or more, and may be 10 or less, or 8 or less. The number of epoxy groups in the polydimethyl siloxane compound may be 1 or more, or 2 or more, and may be 10 or less, or 8 or less. The number of polyether groups in the polydimethyl siloxane compound may be 1 or more, or 2 or more, and may be 10 or less, or 8 or less.

The content of the polydimethyl siloxane compound, from the viewpoint of the lateral pressure resistance and the hot-water resistance, with respect to the total amount of the photopolymerizable compound, may be 0.5% by mass or more and 5.0% by mass or less, 1.0% by mass or more and 4.0% by mass or less, or 1.5% by mass or more and 3.0% by mass or less.

The resin composition according to this embodiment may further contain a silane coupling agent, a leveling agent, an antifoaming agent, an antioxidant, a sensitizer, and the like.

The silane coupling agent is not particularly limited unless the silane coupling agent hinders the curing of the resin composition. Examples of the silane coupling agent include tetramethyl silicate, tetraethyl silicate, mercaptopropyl trimethoxysilane, vinyl trichlorosilane, vinyl triethoxysilane, vinyl tris(β-methoxy-ethoxy) silane, β-(3,4-epoxy cyclohexyl)-ethyl trimethoxysilane, dimethoxydimethyl silane, diethoxydimethyl silane, 3-acryloxypropyl trimethoxysilane, γ-glycidoxypropyl trimethoxysilane, γ-glycidoxypropyl methyl diethoxysilane, γ-methacryloxypropyl trimethoxysilane, N-(β-aminoethyl)-γ-aminopropyl trimethoxysilane, N-(β-aminoethyl)-γ-aminopropyl trimethyl dimethoxysilane, N-phenyl-γ-aminopropyl trimethoxysilane, γ-chloropropyl trimethoxysilane, γ-mercaptopropyl trimethoxysilane, γ-aminopropyl trimethoxysilane, bis-[3-(triethoxysilyl) propyl] tetrasulfide, bis-[3-(triethoxysilyl) propyl] disulfide, γ-trimethoxysilyl propyl dimethyl thiocarbamoyl tetrasulfide, and γ-trimethoxysilyl propyl benzothiazyl tetrasulfide.

The viscosity of the resin composition according to this embodiment at 25° C., from the viewpoint of storage stability, may be 1000 mPa·s or more, 1500 mPa·s or more, or 2000 mPa·s or more, and from the viewpoint of applicability, may be less than 10000 mPa·s, 8000 mPa·s or less, or 6000 mPa·s or less.

From the viewpoint of improving the lateral pressure resistance and the damage resistance of the optical fiber, the Young's modulus of a resin film when curing the resin composition with an ultraviolet ray in a condition of 1000±100 mJ/cm² may be 600 MPa or more and 3000 MPa or less, 650 MPa or more and 2000 MPa or less, or 700 MPa or more and 1300 MPa or less at 23° C.

The resin composition according to this embodiment can be preferably used as a colored coating material of the optical fiber. By forming the outermost layer of the coating resin layer using the colored coating material containing the resin composition according to this embodiment, it is possible to produce the optical fiber less likely to cause the color peeling.

### (Optical Fiber)

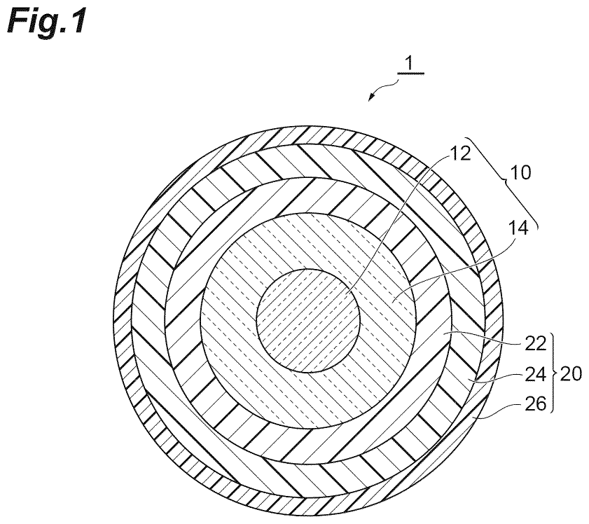

FIG. 1 is a schematic cross-sectional view illustrating the configuration of an optical fiber according to one embodiment. As illustrated in FIG. 1, an optical fiber 1 of this embodiment includes a glass fiber 10, and a coating resin layer 20 covering the outer circumference of the glass fiber 10 in contact with the glass fiber 10.

The glass fiber 10 is a conductive optical transmission medium transmitting light introduced into the optical fiber 1. The glass fiber 10 is a glass member, and for example, is configured by using silica (SiO₂) glass as a base material (a main component). The glass fiber 10 includes a core 12, and a clad 14 covering the core 12. The core 12, for example, is provided in a region including the central axis line of the glass fiber 10. The core 12, for example, consists of pure SiO₂ glass, or SiO₂ glass in which germanium dioxide (GeO₂), a fluorine element, and the like are contained. The clad 14 is provided in a region surrounding the core 12. The clad 14 has a refractive index lower than the refractive index of the core 12. The clad 14, for example, consists of pure SiO₂ glass, or SiO₂ glass to which a fluorine element is added. The outer diameter of the glass fiber 10 is approximately 100 to 125 μm, and the diameter of the core 12 configuring the glass fiber 10 is approximately 7 to 15 μm.

The coating resin layer 20 is an ultraviolet curable resin layer covering the clad 14. The coating resin layer 20 includes a primary resin layer 22 covering the outer circumference of the glass fiber 10, a secondary resin layer 24 covering the outer circumference of the primary resin layer 22, and a colored resin layer 26 covering the outer circumference of the secondary resin layer 24. The primary resin layer 22 is in contact with the outer circumferential surface of the clad 14, and is covering the entire clad 14. The secondary resin layer 24 is in contact with the outer circumferential surface of the primary resin layer 22, and is covering the entire primary resin layer 22. The colored resin layer 26 is in contact with the outer circumferential surface of the secondary resin layer 24, and is covering the outer circumference of the secondary resin layer 24.

The thickness of the primary resin layer 22, for example, is 10 μm or more and 50 μm or less. The thickness of the secondary resin layer 24, for example, is 10 μm or more and 40 μm or less. The thickness of the colored resin layer 26, for example, is 3 μm or more and 10 μm or less.

The primary resin layer 22 may be formed by using a known resin composition for a primary resin layer of the related art. The primary resin layer 22, for example, can be formed by curing a resin composition containing a urethane (meth)acrylate, a monomer, a photopolymerization initiator, and a silane coupling agent. As the photopolymerization initiator in the resin composition for a primary resin layer, the liquid acyl phosphine oxide compound described above may be used.

The secondary resin layer 24 may be formed by using a known resin composition for a secondary resin layer of the related art. The secondary resin layer 24, for example, can be formed by curing a resin composition containing a urethane (meth)acrylate, a monomer, and a photopolymerization initiator. As the photopolymerization initiator in the resin composition for a secondary resin layer, the liquid acyl phosphine oxide compound described above may be used.

The colored resin layer 26 can be formed by curing the resin composition according to this embodiment. By the colored resin layer 26 containing a cured product of the resin composition according to this embodiment, it is possible to suppress the color peeling of the optical fiber.

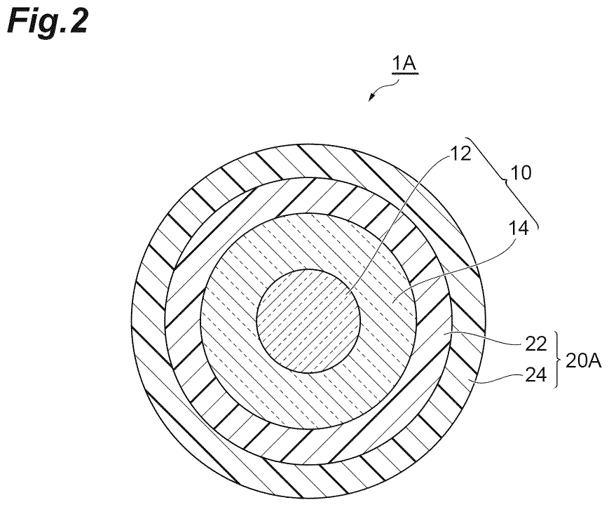

FIG. 2 is a schematic cross-sectional view illustrating the configuration of an optical fiber according to one embodiment. As illustrated in FIG. 2, an optical fiber 1A includes the glass fiber 10, and a coating resin layer 20A covering the outer circumference of the glass fiber 10 in contact with the glass fiber 10. The coating resin layer 20A includes the primary resin layer 22 and the secondary resin layer 24.

The resin composition according to this embodiment can be applied to the secondary resin layer 24. The secondary resin layer 24 can be formed by curing the resin composition according to this embodiment. In this case, the secondary resin layer 24 functions as a colored secondary resin layer. By the secondary resin layer 24 containing the cured product of the resin composition according to this embodiment, it is possible to suppress the color peeling of the optical fiber.

### (Optical Fiber Ribbon)

It is possible to produce an optical fiber ribbon using the optical fiber according to this embodiment. In the optical fiber ribbon, a plurality of optical fibers are arranged in parallel, and coated with a ribbon resin.

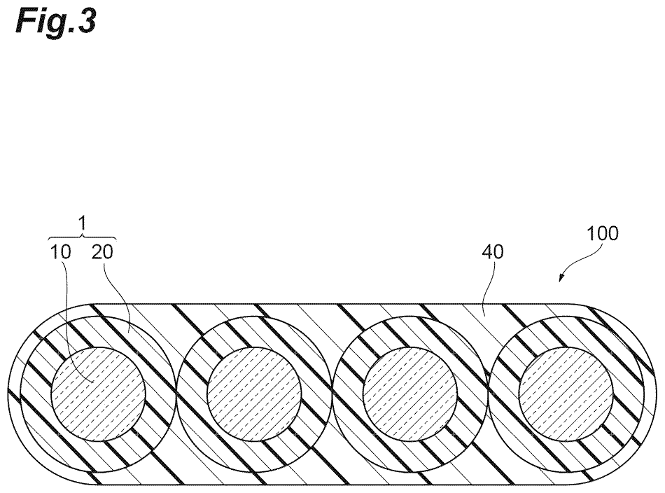

FIG. 3 is a schematic cross-sectional view illustrating an optical fiber ribbon according to this embodiment. An optical fiber ribbon 100 includes a plurality of optical fibers 1, and a connecting resin layer 40 in which the optical fibers 1 are connected by being coated with the ribbon resin. In FIG. 3, as an example, four optical fibers are illustrated, but the number of optical fibers is not particularly limited.

As the ribbon resin, a resin material generally known as a ribbon material can be used. The ribbon resin, from the viewpoint of the damage prevention properties, the ease of separation, or the like of the optical fiber, may contain a thermosetting resin such as a silicone resin, an epoxy resin, and a urethane resin, or an ultraviolet curable resin such as epoxy acrylate, urethane acrylate, and polyester acrylate.

By using the optical fiber described above, the optical fiber ribbon according to this embodiment is less likely to cause the color peeling when performing an operation of extracting the optical fiber by removing the connecting resin layer from the optical fiber ribbon, and is capable of easily identifying the optical fiber.

### EXAMPLES

Hereinafter, the present disclosure will be described in more detail by results of evaluation tests using Examples and Comparative Example according to the present disclosure. Note that, the present invention is not limited to Examples.

### [Resin Composition for Colored Resin Layer]

A photopolymerizable compound at a blended amount (parts by mass) shown in Table 1, and a photopolymerization initiator, a polydimethyl siloxane compound, and titanium oxide particles at a content (% by mass) shown in Table 1 were mixed to prepare a resin composition. Note that, the content of the photopolymerization initiator, the polydimethyl siloxane compound, and the titanium oxide particles is a numerical value with respect to the total amount of the photopolymerizable compound. Test Examples 1 to 3 correspond to Examples, and Test Example 4 corresponds to Comparative Example.

The details of each component shown in Table 1 are as follows.

### (Photopolymerizable Compound)

EA: bisphenol A epoxy diacrylate

PPGDA: polypropylene glycol diacrylate (number of POs: 3)

TMP(EO)₃TA: trimethylol propane EO addition triacrylate (number of EOs: 3)

TMP(EO)₁₅TA: trimethylol propane EO addition triacrylate (number of EOs: 15)

BPA(EO)₃₀DA: EO-modified bisphenol A di(meth)acrylate (number of EOs: 30)

### (Photopolymerization Initiator)

Omnirad 184:1-hydroxycyclohexyl phenyl ketone

Omnirad TPO-L: ethyl phenyl (2,4,6-trimethyl benzoyl) phosphinate (in a liquid state at 25° C.)

Omnipol TP: tri[phenyl (2,4,6-trimethyl benzoyl) phosphinic acid] polyethylene glycol ester (in a liquid state at 25° C.; having a structure represented by Formula (1) described below)

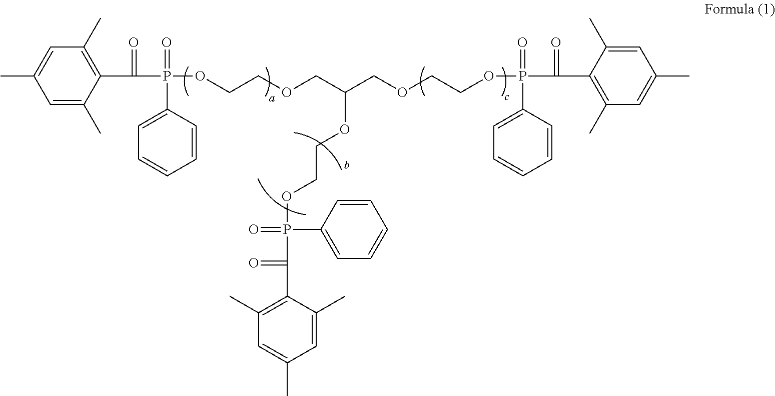

(In Formula (1), a, b, and c are each independently an integer of 0 or more, and a+b+c is 3 or more.)

Omnirad 820: di(2,4,6-trimethyl benzoyl) phosphinic acid polyethylene glycol ester (in a liquid state at 25° C.; having a structure represented by Formula (2) described below)

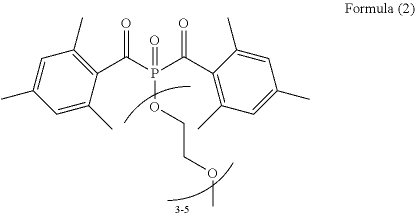

Omnirad TPO-H: 2,4,6-trimethyl benzoyl diphenyl phosphine oxide (in a solid state at 25° C.)

### (Polydimethyl Siloxane Compound)

PDMS: a polydimethyl siloxane compound in which the amount of Si is 21% by mass

### (Titanium Oxide Particles)

TiO₂ Particles: surface-treated titanium oxide particles (average primary particle diameter: 200 to 300 nm; amount of Al₂O₃ calculated by measurement using ICP-MS: 2.5% by mass) including a surface-treated layer containing aluminum oxide (Al₂O₃)

### (Young's Modulus)

The resin composition was applied onto a polyethylene terephthalate (PET) film using a spin coater, and then, cured by using an electrodeless UV lamp system (“VPS 600” (D Bulb), manufactured by Heraeus Group) in a condition of 1000±100 mJ/cm² to form a resin layer with a thickness of 50±5 μm on the PET film. The resin layer was peeled off from the PET film to obtain a resin film.

The resin film was punched out into the shape of a dumbbell of JIS K 7127 Type 5, and pulled out using a tension tester in a condition of 23±2° C. and 50±10% RH and in a condition of a tension rate of 1 mm/minute and a marked line-to-marked line distance of 25 mm to obtain a stress-strain curve. The Young's modulus of the film was determined from 2.5% secant line

### (Viscosity)

The viscosity of the resin composition at 25° C. was measured by using a rheometer (“MCR-102”, manufactured by Anton Paar GmbH) in a condition of a cone plate CP25-2 and a shear rate of 10 s⁻¹.

### [Resin Composition for Primary Resin Layer]

Urethane acrylate obtained by a reaction between polypropylene glycol with a molecular weight of 4000, isophorone diisocyanate, hydroxyethyl acrylate, and methanol was prepared. 75 parts by mass of the urethane acrylate, 12 parts by mass of nonyl phenol EO-modified acrylate, 6 parts by mass of N-vinyl caprolactam, 2 parts by mass of 1,6-hexanediol diacrylate, 1 part by mass of Omnirad TPO-H, and 1 part by mass of 3-mercaptopropyl trimethoxysilane were mixed to prepare a resin composition P.

### [Resin Composition for Secondary Resin Layer]

Urethane acrylate obtained by a reaction between polypropylene glycol with a molecular weight of 600, 2,4-tolylene diisocyanate, and 2-hydroxyethyl acrylate was prepared. 40 parts by mass of the urethane acrylate, 35 parts by mass of isobornyl acrylate, 24 parts by mass of epoxy acrylate that is an acrylic acid adduct of bisphenol A diglycidyl ether, 1 part by mass of Omnirad TPO-H, and 1 part by mass of Omnirad 184 were mixed to prepare a resin composition S.

### [Resin Composition for Ribbon]

Urethane acrylate A obtained by a reaction between bisphenol A/ethylene oxide addition diol, tolylene diisocyanate, and hydroxyethyl acrylate, and urethane acrylate B obtained by a reaction between polytetramethylene glycol, tolylene diisocyanate, and hydroxyethyl acrylate were prepared. 18 parts by mass of the urethane acrylate A, 10 parts by mass of the urethane acrylate B, 15 parts by mass of tricyclodecane dimethanol diacrylate, 10 parts by mass of N-vinyl pyrrolidone, 10 parts by mass of isobornyl acrylate, 5 parts by mass of bisphenol A/ethylene oxide addition diol diacrylate, 0.7 parts by mass of 2-methyl-1-[4-(methyl thio)phenyl]-2-morpholino-propan-1-one (Omnirad 907), and 1.3 parts by mass of Omnirad TPO-H were mixed to prepare a resin composition R.

### [Production of Optical Fiber]

A primary resin layer with a thickness of 17.5 μm was formed by using the resin composition P on the outer circumference of a glass fiber with a diameter of 125 μm, which is composed of a core and a clad, and a secondary resin layer of 15 μm was formed by using the resin composition S on the outer circumference thereof to produce an optical fiber. Next, the optical fiber was wound once, and then, a colored resin layer with a thickness of 5 μm was formed by using the resin composition of Test Examples 1 to 4 on the outer circumference of the secondary resin layer while rewinding the optical fiber with a coloring machine to produce an optical fiber (hereinafter, referred to as a “colored optical fiber”) with a diameter of 200 μm including the colored resin layer. A linear speed when forming each resin layer was set to 1500 m/minute.

### [Production of Optical Fiber Ribbon]

Four colored optical fibers were prepared, coated with the resin composition R for a ribbon, and then, cured by ultraviolet irradiation to form a connecting resin layer, and an optical fiber ribbon was produced.

### (Color Peeling Test)

The optical fiber ribbon was stored for 120 days in a dark place of 85° C./85% RH, and then, the optical fiber was subjected to single-core separation from the optical fiber ribbon, on the basis of Telcordia GR-20 5.3.1. In this case, the presence or absence of the peeling of the colored resin layer was evaluated. A case where there was no peeling in the colored resin layer was evaluated as “A”, a case where a part of a ribbon resin remained in the colored resin layer was evaluated as “B”, and a case where there was peeling in the colored resin layer was evaluated as “C”.

TABLE 1

| | | Test Example | | | |
|---|---|---|---|---|---|
| | | 1 | 2 | 3 | 4 |
| EA | (parts by mass) | 55.0 | 55.0 | 55.0 | 55.0 |
| PPGDA | | 15.0 | 15.0 | 15.0 | 15.0 |
| TMP(EO)₃TA | | 10.0 | 10.0 | 10.0 | 10.0 |
| TMP(EO)₁₅TA | | 10.0 | 10.0 | 10.0 | 10.0 |
| BPA(EO)₃₀DA | | 10.0 | 10.0 | 10.0 | 10.0 |
| Omnirad 184 | (% by mass) | 5.0 | 5.0 | 5.0 | 5.0 |
| Omnirad TPO-L | | 1.0 | — | — | — |
| Omnirad TP | | — | 1.0 | — | — |
| Omnirad 820 | | — | — | 1.0 | — |
| Omnirad TPO-H | | — | — | — | 1.0 |
| PDMS | | 2.0 | 2.0 | 2.0 | 2.0 |
| TiO₂ particles | | 5.0 | 5.0 | 5.0 | 5.0 |

| | | | | |
|---|---|---|---|---|
| Young's modulus (MPa) | 1000 | 1000 | 1000 | 1000 |
| Viscosity (mPa · s) | 4000 | 4000 | 4000 | 4000 |
| Color peeling test | A | A | A | B |

What is claimed is:

1. A resin composition for colored coating on an optical fiber, comprising:
a photopolymerizable compound; and
a photopolymerization initiator,
wherein the photopolymerization initiator contains an acyl phosphine oxide compound that is in a liquid state at 25° C.

2. The resin composition according to claim 1,
wherein the acyl phosphine oxide compound has at least one 2,4,6-trimethyl benzoyl group.

3. The resin composition according to claim 1,
wherein the acyl phosphine oxide compound includes at least one type selected from the group consisting of ethyl phenyl (2,4,6-trimethyl benzoyl) phosphinate, di(2,4,6-trimethyl benzoyl) phosphinic acid polyethylene glycol ester, and tri[phenyl (2,4,6-trimethyl benzoyl) phosphinic acid] polyethylene glycol ester.

4. The resin composition according to claim 1,
wherein a content of the acyl phosphine oxide compound is 0.01% by mass or more and 5.0% by mass or less with respect to a total amount of the photopolymerizable compound.

5. The resin composition according to claim 1, further comprising
a titanium oxide particle.

6. An optical fiber, comprising:
a glass fiber including a core and a clad;
a primary resin layer covering the glass fiber in contact with the glass fiber;
a secondary resin layer covering the primary resin layer; and
a colored resin layer covering the secondary resin layer,
wherein the colored resin layer contains a cured product of the resin composition according to claim 1.

7. An optical fiber, comprising:
a glass fiber including a core and a clad;
a primary resin layer covering the glass fiber in contact with the glass fiber; and
a secondary resin layer covering the primary resin layer,
wherein the secondary resin layer contains a cured product of the resin composition according to claim 1.

8. An optical fiber ribbon in which a plurality of the optical fibers according to claim 6 are arranged in parallel, and coated with a ribbon resin.

9. An optical fiber ribbon in which a plurality of the optical fibers according to claim 7 are arranged in parallel, and coated with a ribbon resin.
